(19) United States
(12) Patent Application Publication
(10) Pub. No.: US 2019/0169008 A1
(43) Pub. Date: Jun. 6, 2019

(54) GYROSCOPICALLY STABILIZED VEHICLE SYSTEM

(71) Applicant: Hand Held Products, Inc., Fort Mill, SC (US)

(72) Inventor: Scott Xavier Houle, Edmonds, WA (US)

(21) Appl. No.: 15/829,013

(22) Filed: Dec. 1, 2017

(51) Int. Cl. B66F 9/075

(52) U.S. Cl. CPC B66F 9/07559

(57) ABSTRACT

A method of self-stabilizing a forklift having a volume dimensioning device, a weight sensor, and a gyroscopic disc when the forklift is lifting an object, comprises: determining dimensions and volume of the object with the volume dimensioning device; determining a weight of the object with the weight sensor; calculating an approximate center of gravity of the object; and stabilizing the forklift when lifting the object by rotating the gyroscopic disc at a rotational speed based on the determined weight and calculated approximate center of gravity of the object.

### FIELD OF THE INVENTION

The invention is generally related to industrial vehicle stabilization systems, and, more specifically, to gyroscopically stabilized industrial vehicle systems.

### BACKGROUND

Industrial vehicles, such as forklifts, are commonly used in warehouse and industrial settings to move and place objects. Often these objects are very heavy, necessitating conventional forklifts to be proportionally built to properly balance these heavy loads. As a general rule, the actual weight of a forklift (i.e. service weight) will be 1.5 to 2 times the lift capacity of the forklift. For example, if a forklift has a lifting capacity of 5,000 pounds, the service weight of the forklift will be somewhere between 7,500-10,000 pounds. This excessive weight helps the forklift, in combination with adjustable fulcrum points, to properly balance heavy loads without tipping over.

While the excessive weight helps properly balance heavy loads, the excessive weight comes at a cost of requiring large motors to operate the forklift. These large motors contribute to an increased service weight, and consume large quantities of energy to operate. Additionally, when lifting lighter loads, the forklift does not need all of the service weight in order to balance the load. However, the large motor will still consume large quantities of energy to move the unneeded weight.

If an industrial vehicle such as a forklift could be made lighter while maintaining the same lifting capacity as a conventional forklift, then the forklift could use a smaller motor, and the user could reduce operational costs.

### SUMMARY

In an embodiment, a method of self-stabilizing a forklift having a volume dimensioning device, a weight sensor, and a gyroscopic disc when the forklift is lifting an object, comprises: determining dimensions and volume of the object with the volume dimensioning device; determining a weight of the object with the weight sensor; calculating an approximate center of gravity of the object; and stabilizing the forklift when lifting the object by rotating the gyroscopic disc at a rotational speed based on the determined weight and calculated approximate center of gravity of the object.

In an embodiment, the volume dimensioning device is a 3D range camera.

In an embodiment, the weight sensor is a barcode reader operable to read a barcode positioned on the object, the barcode encoding a weight of the object.

In another embodiment, the forklift comprises a plurality of gyroscopic discs.

In an embodiment, the method comprises rotating two or more gyroscopic discs when the forklift lifts the object, the rotational speed of the rotating gyroscopic discs being based on the approximate center of gravity and determined weight of the object.

In an embodiment, each gyroscopic disc has a different diameter and weight than the other gyroscopic discs.

In another embodiment, when a total stabilizing force generated by rotating all the plurality of gyroscopic discs exceeds a stabilizing force needed to stabilize the forklift when lifting the object, a first gyroscopic disc is rotated, and a second gyroscopic disc remains stationary.

In an embodiment, the forklift further comprises a processor in communication with the volume dimensioning device and weight sensor, the processor being operable to: receive the calculated volume and dimensions from the volume dimensioning device, and the determined weight from the weight sensor; perform the calculation of the approximate center of gravity of the object based on the calculated volume and dimensions and determined weight of the object; control a rotational speed of the gyroscopic disc; and responsive to the calculated approximate center of gravity and determined weight of the object, adjust the rotational speed of the gyroscopic disc.

In an embodiment, the volume dimensioning device is positioned on a mast of the forklift.

In another embodiment, the weight sensor is attached to a mast of the forklift and is configured to measure the weight of the object as the object is lifted by the forklift.

In yet another embodiment, a method of stabilizing a forklift, comprises: determining a weight of an object with a weight sensor; determining dimensions and volume of the object with a volume dimensioning device; calculating an approximate center of gravity of the object based on the determined dimensions and volume of the object; rotating a gyroscopic disc positioned in a disc receiving space of the forklift at a rotational speed sufficient to stabilize the forklift when lifting the object, the rotational speed of the gyroscopic disc being based on the approximate center of gravity and the determined weight of the object.

In an embodiment, the volume dimensioning device is a 3D range camera.

In another embodiment, the volume dimension device is attached to a mast of the forklift.

In another embodiment, the weight sensor is attached to a mast of the forklift and is configured to measure the weight of the object as the object is lifted by the forklift.

In an embodiment, the forklift comprises a processor in communication with the volume dimensioning device and weight sensor, the processor being configured to calculate the approximate center of gravity.

In an embodiment, the processor is in communication with a motor controlling a rotational speed of gyroscopic disc, and instructs the motor to adjust the rotational speed of the gyroscopic disc in response to the determined weight and approximate center of gravity of the object.

In another embodiment, the forklift comprises a plurality of gyroscopic discs.

In a further embodiment, each gyroscopic disc has a different diameter and weight than the other gyroscopic discs.

In an embodiment, when a total stabilizing force generated by rotating all the plurality of gyroscopic discs exceeds a stabilizing force needed to stabilize the forklift when lifting the object, a first gyroscopic disc is rotated, and a second gyroscopic disc remains stationary.

In another embodiment, the weight sensor is a barcode reader operable to read a barcode positioned on an object to be lifted, the barcode encoding a weight of the object.

### BRIEF DESCRIPTION OF THE DRAWINGS

The invention will now be described by way of example with reference to the accompanying figures, of which:

FIG. 1 is a side view of an industrial vehicle;

FIG. 2 is a side view of an industrial vehicle and a volume dimensioning device;

FIG. 3 is a side view of an industrial vehicle and a weight sensor;

FIG. 4 is a schematic view of a computing device communicatively connected to a volume dimensioning device and a weight sensor;

FIG. 5 is an exploded view of a plurality of gyroscopic discs;

FIG. 6 is a perspective view of the plurality of gyroscopic discs stacked;

FIG. 7 is a block diagram of a method of gyroscopically stabilizing an industrial vehicle with a gyroscopic disc;

FIG. 8 is a block diagram of a method of gyroscopically stabilizing an industrial vehicle with a plurality of gyroscopic discs; and

FIG. 9 is a block diagram of a method of controlling a gyroscopically stabilized industrial vehicle with a plurality of gyroscopic discs.

### DETAILED DESCRIPTION

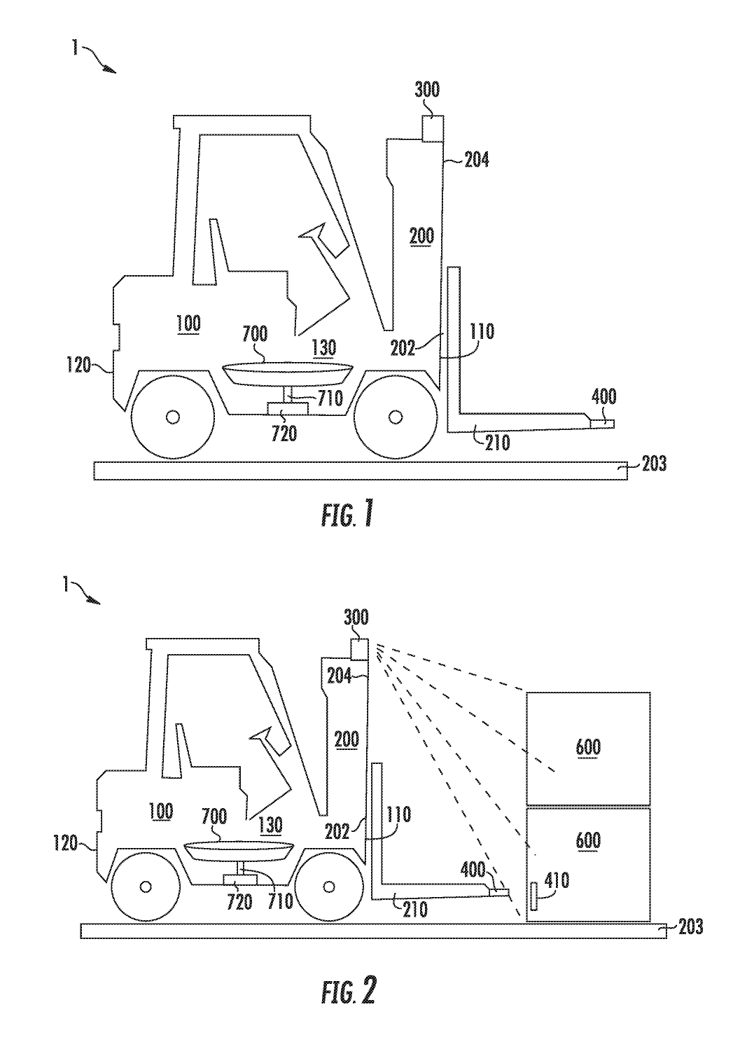

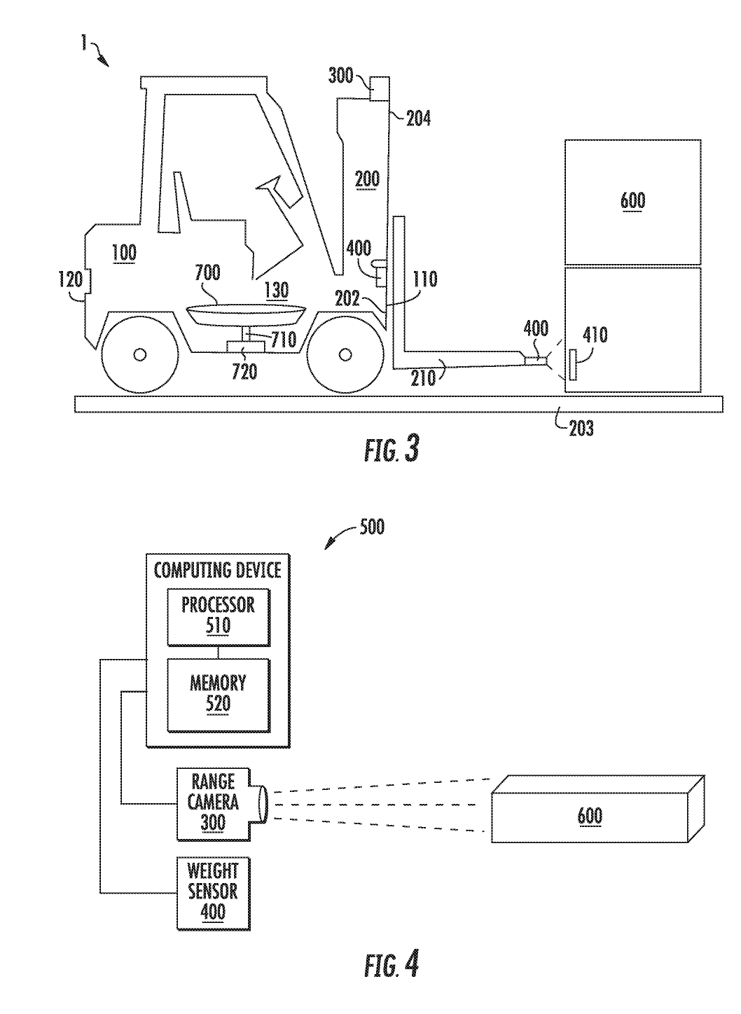

Embodiments of the invention will now be described with reference to FIGS. 1-9.

An industrial vehicle 1 has a body 100, a mast 200, a volume dimensioning device 300, a weight sensor 400, a computing device 500, and a gyroscopic disc 700.

In an embodiment, the industrial vehicle 1 is a forklift. In another embodiment, the industrial vehicle is a bucket crane vehicle, or any other type of industrial vehicle designed to lift and move objects 600.

In the embodiments of FIG. 1 the body 100 has a first end 110, an opposite second end 120, and a disc receiving space 130. The disc receiving space 130 is positioned between the first end 110 and the second end 120.

In an embodiment, the mast 200 is a vertical mast, as shown in FIG. 1. The mast 200 comprises a lower end 202 proximate to a support surface 203, and an opposite upper end 204 distal to the support surface. A set of forks 210 are operatively connected to the mast 200, and are vertically moveable along a length of the mast 200. The mast 200 is connected at the lower end 202 to the first end 110 of the body 100. The mast 200 can pivot at the lower end 202 to tilt away from the first end 110, or tilt towards the first end 110 in order to adjust a center of gravity of a load placed on the forks 210 by an object 600 being lifted.

In another embodiment, the mast 200 is a horizontal mast (not shown) on a telescopic forklift or boom lift. When the mast 200 is the horizontal mast, the set of forks 210 are operatively connected to a leading end of the horizontal mast, opposite a pivoting end of the mast connected to the second end 120 of the body 100.

The volume dimensioning device 300 measures the dimensions and calculates the volume of the object 600 to be lifted by the industrial vehicle 1. In an embodiment, the volume dimensioning device 300 is a 3D range camera. The 3D range camera can use any method of producing a 3D range image, including but not limited to stereo triangulation, structured light, time-of-flight, and interferometry. The volume dimensioning device 300 can be mounted on the body 100 of the industrial vehicle 1, or can be mounted on the mast 200. For example, as seen in FIGS. 1-3, the volume dimensioning device 300 can be mounted on the upper end 204 of the mast 200, allowing the volume dimensioning device 300 to have a tangential view of the object 600. This orientation permits the volume dimensioning device 300 to observe several planes of the object 600, allowing for a more accurate determination of the object's volume.

The weight sensor 400 measures the weight of an object 600 to be lifted by the industrial vehicle 1. In an embodiment, the weight sensor 400 is a barcode reader operable to read a barcode 410 positioned on the object 600, the barcode 410 encoding a weight of the object 600. In another embodiment, the barcode 410 encodes both a weight and a weight distribution of the object 600. For example, as shown in FIGS. 1-3, when the industrial vehicle 1 is a forklift, the barcode reader 400 can be attached to the forks 210, and can scan a barcode 410 on the object 600 as the industrial vehicle 1 is positioned to lift the object 600. In another example, the barcode reader 400 can be positioned on the first end 110 of the body 100. In yet another example, the barcode reader 400 can be positioned on the mast 200. When the industrial vehicle 1 is a boom lift, the barcode reader 400 can be positioned at a location on the boom or body 100 that will be proximate to the object 600 being lifted.

In embodiment, the weight sensor 400 can be an RFID reader operable to read an RFID tag 410 positioned on the object 600, the RFID tag 410 encoding a weight of the object 600. In another embodiment, the RFID tag 410 encodes both a weight and a weight distribution of the object 600. The RFID reader 400 can be positioned on the front end 110 of the body 100 of the industrial vehicle 1, and can read the RFID tag 410 positioned on the object 600 as the industrial vehicle 1 is positioned to lift the object 600. In another example, the RFID reader 400 can be positioned on the first end 110 of the body 100. In yet another example, the RFID reader 400 can be positioned on the mast 200. When the industrial vehicle 1 is a boom lift, the RFID reader 400 can be positioned at a location on the boom or body 100 that will be proximate to the object 600 being lifted.

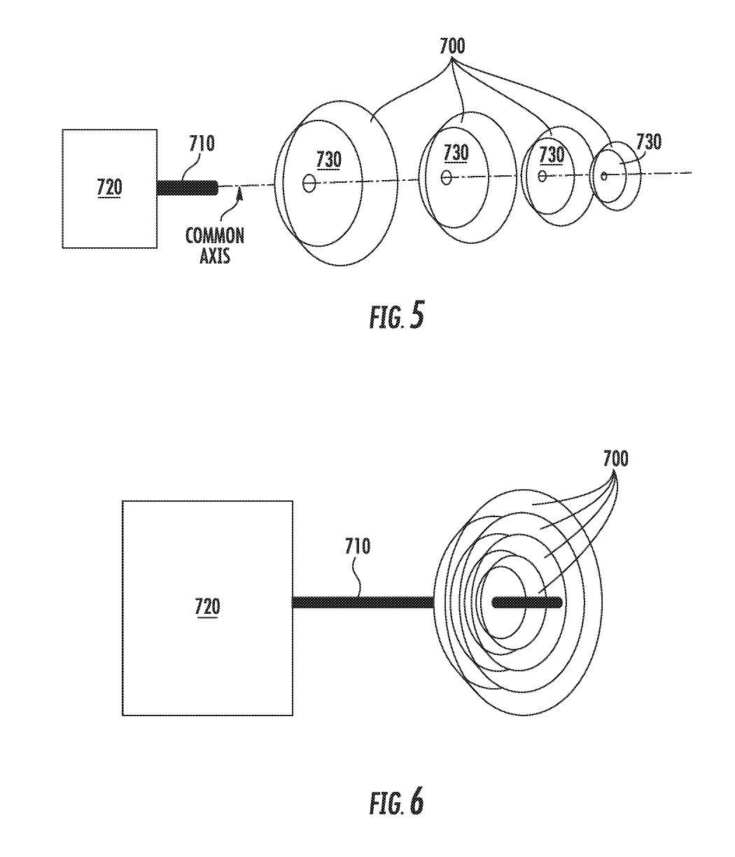

The computing device 500 comprises a processor 510 and a memory 520, as shown in the exemplary embodiment of FIG. 4. Memory 520 can store executable instructions, such as, for example, computer readable instructions (e.g., software), that can be executed by processor 510.

The processor 510 is communicatively connected to the volume dimensioning device 300, and receives the dimensioning data and the calculated volume data of the object 600 from the volume dimensioning device 300. In an embodiment, the processor 510 receives dimensioning data directly from the volume dimensioning device 300, and the processor 510 calculates the volume of the object 600 from the dimensioning data.

The processor 510 is communicatively connected to the weight sensor 400, and receives the weight data of the object 600 from the weight sensor 400.

The processor 510 is configured to determine an approximate center of gravity of the object based on the volume, dimensions, and weight of the object 600. Additionally, the processor 510 is configured to determine the approximate center of gravity of the industrial vehicle 1 as the industrial vehicle 1 carries the object 600. For example, when the industrial vehicle 1 is a forklift, the approximate center of gravity will change as the forklift raises or lowers the object 600.

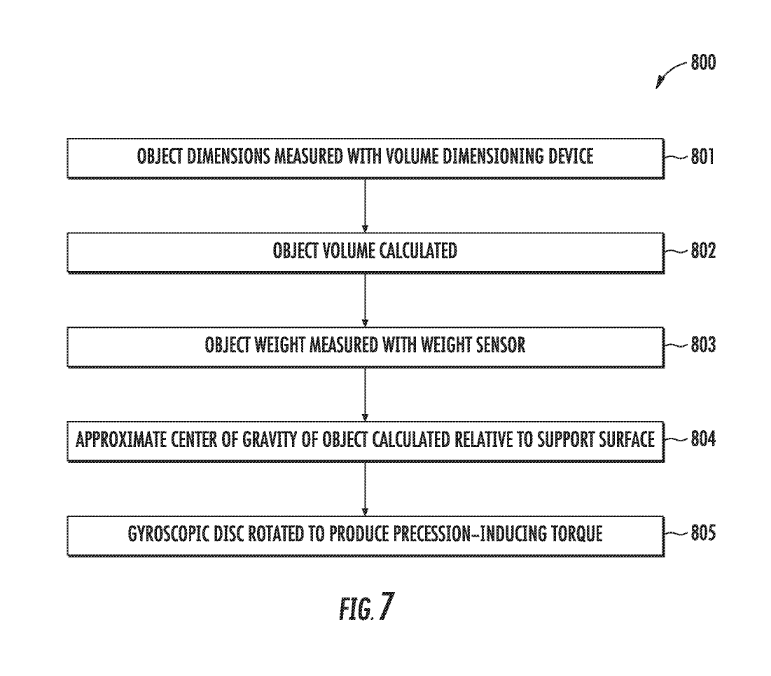

FIGS. 1-3 show a single gyroscopic disc 700 is positioned in the disc receiving space 130 located in the body 100. The gyroscopic disc 700 is mounted on a drive shaft 710 connected to a motor 720 (See FIGS. 5 and 6). The motor 720 can be electric, hydraulic, or any other type of motor commonly used in industrial vehicles, and is controlled by the processor 510. As shown in FIGS. 1-3, the motor 720 can be separate from a motor used to propel the industrial vehicle 1. In another embodiment (not shown), the motor 720 can be the same motor used to propel the industrial vehicle 1, with the rotational speed of the drive shaft 710 being controlled by a known clutch and transmission mechanism.

In another example embodied in FIGS. 1-3, a plurality of gyroscopic discs 700 are positioned in the disc receiving space 130. Each of the plurality of gyroscopic discs 700 can be equal in diameter, thickness, and/or weight, or each of the plurality of gyroscopic discs 700 can have different diameters, thicknesses, and/or weights. Each gyroscopic disc 700 can be mounted on the drive shaft 710 and spun by the motor 720. Further, each gyroscopic disc 700 can be disengaged from the drive shaft 710 such that only a few gyroscopic discs 700 are spun while the remainder of gyroscopic discs 700 remain at rest.

In an embodiment shown in FIGS. 5 and 6, when each of the gyroscopic discs 700 has a different diameter, each gyroscopic disc 700 can have a disc receiving recess 730 that has concentrically smaller or larger diameter than the disc receiving recesses 730 of the other gyroscopic discs 700. When the plurality of different diameter gyroscopic discs 700 are concentrically stacked on each other, each gyroscopic disc 700 is positioned within the disc receiving recess 730 of a larger diameter gyroscopic disc 700.

As shown in FIGS. 1-3, the drive shaft 710 is vertically positioned relative to the support surface 203, forming a vertical spin axis that spins the gyroscopic disc 700 in horizontal plane. In another embodiment (not shown), the drive shaft 710 is horizontally positioned relative to the support surface 203, forming a horizontal spin axis that spins the gyroscopic disc 700 in the vertical plane. In both embodiments, the gyroscopic disc 700 is restricted to rotating about the spin axis determined by the orientation of the drive shaft 710.

In practice, a precession force is generated by spinning the gyroscopic disc 700, and this precession force is used to stabilize the industrial vehicle 1 when carrying a load by simulating the effects of counterweights used in conventional industrial vehicles 1. A spinning gyroscopic disc 700 exerts torque, M, about its torque axis when the gyroscopic disc 700 precesses about its precession axis when a spin velocity is greater than a precession velocity. The effect of the torque, M, is that when the industrial vehicle 1 tilts from vertical, the torque, M, is applied by the spinning gyroscopic disc 700 to the body 100 of the industrial vehicle 1 such that a resulting gyroscopic moment will tend to resist the industrial vehicle 1 from tilting from vertical.

The torque, M, can be expressed by the following equation when the gyroscopic disc 700 is a solid disc with a symmetrical axis:

M=½IΩP

where,
I=mr²=inertia moment of the gyroscopic disc about the spin axis;
Ω=precession velocity;
P=spin velocity of gyroscopic disc;
m=total mass of gyroscopic disc; and
r=radius of gyroscopic disc.

As evidenced in the equation, every change in the diameter of the gyroscopic disc 700 has an exponential effect on the inertia moment, and ultimately on the torque M. Additionally, the spin velocity P of the gyroscopic disc 700 has a linear effect on the torque M.

Thus, the total stabilization effect of the gyroscopic disc 700 on the industrial vehicle 1 is determined by controlling the spin velocity, total mass, and radius of the gyroscopic disc 700. In the embodiment where only a single gyroscopic disc 700 is used, the total mass and radius of the gyroscopic disc 700 are set, so the stabilizing torque M is adjustable by controlling the spin velocity P of the gyroscopic disc 700.

When the gyroscopic disc 700 is hoop-like with a symmetrical axis (e.g. similar in form to a bike tire), the torque, M, can be expressed by the equation:

M=IΩP

where those of ordinary skill in the art would recognize that while the torque, M, produced may be different than the torque, M, produced by a solid disc with a symmetrical axis, the principle remains the same.

The processor 510 can be communicatively connected to the motor 720, and can control the speed of the motor 720, and hence the rotational speed of the drive shaft 710, and ultimately the spin velocity of the gyroscopic disc 700. When a clutch and transmission mechanism is used to turn the drive shaft 710, the processor 510 can also be communicatively connected to the clutch and transmission mechanism to control the rotational speed of the drive shaft 710, and ultimately the spin velocity P of the gyroscopic disc 700.

When a plurality of gyroscopic discs 700 are employed, the processor 510 controls how many of the gyroscopic discs 700 are rotated at the same time, which gyroscopic discs 700 are rotated, and the spin velocity P at which the gyroscopic discs 700 are rotated. For example, as described in more detail below, after the processor 510 has determined the weight and approximate center of gravity of the object 600, the processor 510 can then determine what combination of gyroscopic discs 700 will produce sufficient torque M to stabilize the industrial vehicle 1 while the industrial vehicle 1 picks up the object 600. The particular combination of gyroscopic discs 700 can be determined based on the spin velocity P, total mass m, and radius of the gyroscopic discs 700.

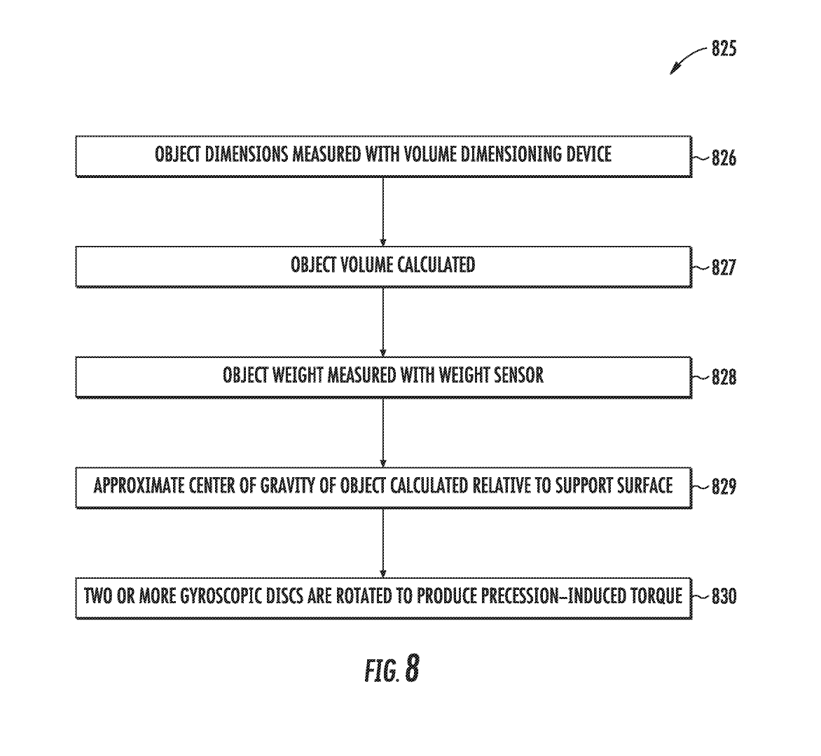

A method 800 of gyroscopically stabilizing an industrial vehicle 1 with a gyroscopic disc 700 will now be described with reference to FIG. 7. At block 801, dimensions of the object 600 are measured with the volume dimensioning device 300; a volume of the object 600 is calculated from the dimensions at block 802; at block 803 a weight of the object 800 is determined with the weight sensor 400; an approximate center of gravity of the object 600 is calculated from the dimensions, volume, and weight of the object relative to a support surface (e.g. the floor) at block 804; and the gyroscopic disc 700 is rotated at a spin velocity P that produces sufficient precession-inducing torque to stabilize the industrial vehicle 1 based on the determined weight and calculated approximate center of gravity of the object 600 at block 805.

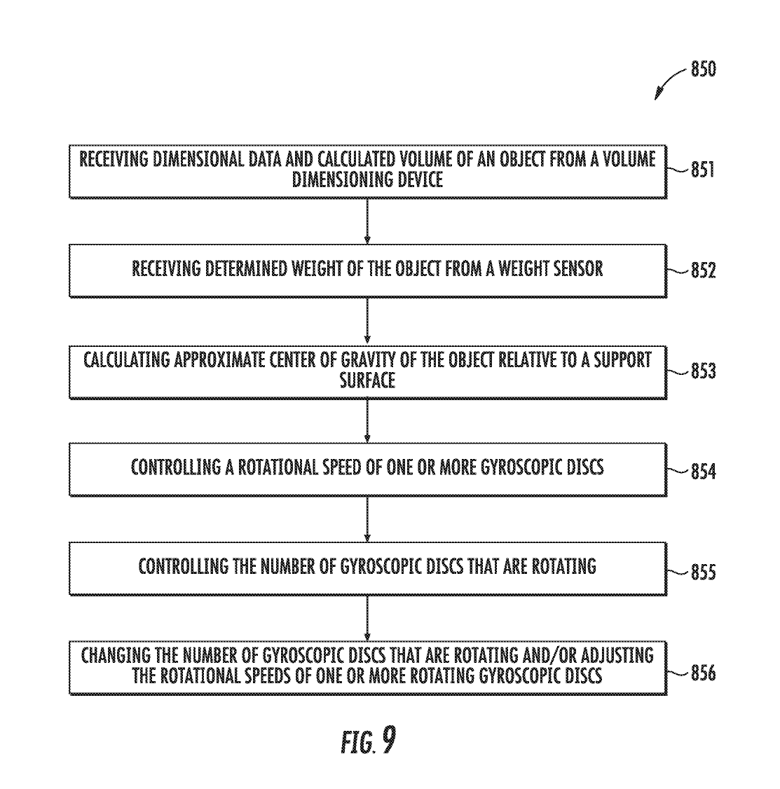

A method 825 of gyroscopically stabilizing an industrial vehicle 1 with a plurality of gyroscopic discs 700 is shown in FIG. 8. At block 826, dimensions of the object 600 are measured with the volume dimensioning device 300; a volume of the object 600 is calculated from the dimensions at block 827; at block 828 a weight of the object 800 is determined with the weight sensor 400; an approximate center of gravity of the object 600 is calculated from the dimensions, volume, and weight of the object relative to a support surface (e.g. the floor) at block 829; and two or more gyroscopic discs 700 are rotated at a spin velocity P that produces sufficient torque M to stabilize the industrial vehicle 1 based on the determined weight and calculated approximate center of gravity of the object 600, while one or more gyroscopic discs 700 remain stationary and are not rotated at block 830. In another embodiment, all of the gyroscopic discs 700 are rotated at a spin velocity P that produces sufficient torque M to stabilize the industrial vehicle 1 at block 830.

FIG. 9 discloses an embodiment of a method 850 of controlling a gyroscopically stabilized industrial vehicle 1 comprising a processor 510 being operable to: receive the dimensions and calculated volume of the object 600 from the volume dimensioning device 300 at block 851, and receive the determined weight of the object 600 from the weight sensor 400 at block 852; perform a calculation of the approximate center of gravity of the object 600 based on the dimensions, calculated volume and determined weight of the object 600 in relation to a support surface (e.g. the floor) at block 853; control a spin velocity P of one or more gyroscopic discs 700 at block 854; control the number of gyroscopic discs 700 that are rotating at block 855; and responsive to the calculated approximate center of gravity and determined weight of the object 600, change the number of gyroscopic discs 700 that are rotating and/or adjust the spin velocity P of the one or more rotating gyroscopic discs 700 at block 856.

In a further embodiment, the processor 510 is operable to control a spin velocity P of the gyroscopic disc 700 based on changes in the calculation of an approximate center of gravity of the object 600 relative to a support surface (e.g. the floor).

In another embodiment, when a plurality of gyroscopic discs 700 are used, the processor 510 activates or deactivates all or a portion of the gyroscopic discs 700 in response to the calculated approximate center of gravity and determined weight of the object 600. For example, when a torque M created by all of the plurality of gyroscopic discs 700 rotating exceeds a needed stabilizing force due to an object 600 that weighs less than the currently produced torque M, the processor 510 will only activate (e.g. rotate) enough of the gyroscopic discs 700 to sufficiently stabilize the industrial vehicle 1, the activation being determined by calculating an optimal torque Min view of the object 600 weight based on the spin velocity P, total mass m, and radius r of the gyroscopic discs 700 (discussed above). Additionally, the processor 510 will control the speed at which the gyroscopic discs 700 are rotated through communicative control over the motor 720. By only activating a subset of the gyroscopic discs 700 rather than all of the gyroscopic discs 700, the energy efficiency of the industrial vehicle 1 is improved.

Advantages of the described industrial vehicle include, but are not limited to a reduction in the weight of the industrial vehicle while maintaining the same lifting capacity as a conventional industrial vehicle using heavy counterweights. Additionally, the industrial vehicle can use a smaller motor than the convention industrial vehicle, since the overall weight of the industrial vehicle has been reduced, correspondingly reducing operational costs by requiring less fuel.

Further, the industrial vehicle will provide a more stable platform over uneven surfaces. For example, when a conventional industrial vehicle encounters an uneven surface, such as a dip or pothole, the conventional industrial vehicle's tires will follow the uneven surface into the dip, causing the conventional industrial vehicle to rock or shudder. When the conventional industrial vehicle is, for example, a forklift, this rocking motion can destabilize heavy loads, and can cause the heavy load to topple. However, when the industrial vehicle 1, encounters an uneven surface, the inertial torque generated by the gyroscopic disc will serve to stabilize the industrial vehicle by resisting the tendency of the industrial vehicle to rock or shudder. Instead, the industrial vehicle may “float” over the uneven surface, or the tires will more slowly enter into the uneven surface, reducing any sudden jarring motions.

To supplement the present disclosure, this application incorporates entirely by reference the following patents, patent application publications, and patent applications:
U.S. Pat. Nos. 6,832,725; 7,128,266;
U.S. Pat. Nos. 7,159,783; 7,413,127;
U.S. Pat. Nos. 7,726,575; 8,294,969;
U.S. Pat. Nos. 8,317,105; 8,322,622;
U.S. Pat. Nos. 8,366,005; 8,371,507;
U.S. Pat. Nos. 8,376,233; 8,381,979;
U.S. Pat. Nos. 8,390,909; 8,408,464;
U.S. Pat. Nos. 8,408,468; 8,408,469;
U.S. Pat. Nos. 8,424,768; 8,448,863;
U.S. Pat. Nos. 8,457,013; 8,459,557;
U.S. Pat. Nos. 8,469,272; 8,474,712;
U.S. Pat. Nos. 8,479,992; 8,490,877;
U.S. Pat. Nos. 8,517,271; 8,523,076;
U.S. Pat. Nos. 8,528,818; 8,544,737;
U.S. Pat. Nos. 8,548,242; 8,548,420;
U.S. Pat. Nos. 8,550,335; 8,550,354;
U.S. Pat. Nos. 8,550,357; 8,556,174;
U.S. Pat. Nos. 8,556,176; 8,556,177;
U.S. Pat. Nos. 8,559,767; 8,599,957;
U.S. Pat. Nos. 8,561,895; 8,561,903;
U.S. Pat. Nos. 8,561,905; 8,565,107;
U.S. Pat. Nos. 8,571,307; 8,579,200;
U.S. Pat. Nos. 8,583,924; 8,584,945;
U.S. Pat. Nos. 8,587,595; 8,587,697;
U.S. Pat. Nos. 8,588,869; 8,590,789;
U.S. Pat. Nos. 8,596,539; 8,596,542;
U.S. Pat. Nos. 8,596,543; 8,599,271;
U.S. Pat. Nos. 8,599,957; 8,600,158;
U.S. Pat. Nos. 8,600,167; 8,602,309;
U.S. Pat. Nos. 8,608,053; 8,608,071;
U.S. Pat. Nos. 8,611,309; 8,615,487;
U.S. Pat. Nos. 8,616,454; 8,621,123;
U.S. Pat. Nos. 8,622,303; 8,628,013;
U.S. Pat. Nos. 8,628,015; 8,628,016;
U.S. Pat. Nos. 8,629,926; 8,630,491;
U.S. Pat. Nos. 8,635,309; 8,636,200;
U.S. Pat. Nos. 8,636,212; 8,636,215;
U.S. Pat. Nos. 8,636,224; 8,638,806;
U.S. Pat. Nos. 8,640,958; 8,640,960;
U.S. Pat. Nos. 8,643,717; 8,646,692;
U.S. Pat. Nos. 8,646,694; 8,657,200;
U.S. Pat. Nos. 8,659,397; 8,668,149;
U.S. Pat. Nos. 8,678,285; 8,678,286;
U.S. Pat. Nos. 8,682,077; 8,687,282;
U.S. Pat. Nos. 8,692,927; 8,695,880;
U.S. Pat. Nos. 8,698,949; 8,717,494;
U.S. Pat. Nos. 8,717,494; 8,720,783;
U.S. Pat. Nos. 8,723,804; 8,723,904;
U.S. Pat. Nos. 8,727,223; 8,740,082;
U.S. Pat. Nos. 8,740,085; 8,746,563;
U.S. Pat. Nos. 8,750,445; 8,752,766;
U.S. Pat. Nos. 8,756,059; 8,757,495;
U.S. Pat. Nos. 8,760,563; 8,763,909;
U.S. Pat. Nos. 8,777,108; 8,777,109;
U.S. Pat. Nos. 8,779,898; 8,781,520;
U.S. Pat. Nos. 8,783,573; 8,789,757;
U.S. Pat. Nos. 8,789,758; 8,789,759;
U.S. Pat. Nos. 8,794,520; 8,794,522;
U.S. Pat. Nos. 8,794,525; 8,794,526;
U.S. Pat. Nos. 8,798,367; 8,807,431;
U.S. Pat. Nos. 8,807,432; 8,820,630;
U.S. Pat. Nos. 8,822,848; 8,824,692;
U.S. Pat. Nos. 8,824,696; 8,842,849;
U.S. Pat. Nos. 8,844,822; 8,844,823;
U.S. Pat. Nos. 8,849,019; 8,851,383;
U.S. Pat. Nos. 8,854,633; 8,866,963;
U.S. Pat. Nos. 8,868,421; 8,868,519;
U.S. Pat. Nos. 8,868,802; 8,868,803;
U.S. Pat. Nos. 8,870,074; 8,879,639;
U.S. Pat. Nos. 8,880,426; 8,881,983;
U.S. Pat. Nos. 8,881,987; 8,903,172;
U.S. Pat. Nos. 8,908,995; 8,910,870;
U.S. Pat. Nos. 8,910,875; 8,914,290;
U.S. Pat. Nos. 8,914,788; 8,915,439;
U.S. Pat. Nos. 8,915,444; 8,916,789;
U.S. Pat. Nos. 8,918,250; 8,918,564;
U.S. Pat. Nos. 8,925,818; 8,939,374;
U.S. Pat. Nos. 8,942,480; 8,944,313;
U.S. Pat. Nos. 8,944,327; 8,944,332;
U.S. Pat. Nos. 8,950,678; 8,967,468;
U.S. Pat. Nos. 8,971,346; 8,976,030;
U.S. Pat. Nos. 8,976,368; 8,978,981;
U.S. Pat. Nos. 8,978,983; 8,978,984;
U.S. Pat. Nos. 8,985,456; 8,985,457;
U.S. Pat. Nos. 8,985,459; 8,985,461;
U.S. Pat. Nos. 8,988,578; 8,988,590;
U.S. Pat. Nos. 8,991,704; 8,996,194;
U.S. Pat. Nos. 8,996,384; 9,002,641;
U.S. Pat. Nos. 9,007,368; 9,010,641;
U.S. Pat. Nos. 9,015,513; 9,016,576;
U.S. Pat. Nos. 9,022,288; 9,030,964;
U.S. Pat. Nos. 9,033,240; 9,033,242;
U.S. Pat. Nos. 9,036,054; 9,037,344;
U.S. Pat. Nos. 9,038,911; 9,038,915;
U.S. Pat. Nos. 9,047,098; 9,047,359;
U.S. Pat. Nos. 9,047,420; 9,047,525;
U.S. Pat. Nos. 9,047,531; 9,053,055;
U.S. Pat. Nos. 9,053,378; 9,053,380;
U.S. Pat. Nos. 9,058,526; 9,064,165;
U.S. Pat. Nos. 9,064,165; 9,064,167;
U.S. Pat. Nos. 9,064,168; 9,064,254;
U.S. Pat. Nos. 9,066,032; 9,070,032;
U.S. Pat. Nos. 9,076,459; 9,079,423;
U.S. Pat. Nos. 9,080,856; 9,082,023;
U.S. Pat. Nos. 9,082,031; 9,084,032;
U.S. Pat. Nos. 9,087,250; 9,092,681;
U.S. Pat. Nos. 9,092,682; 9,092,683;
U.S. Pat. Nos. 9,093,141; 9,098,763;
U.S. Pat. Nos. 9,104,929; 9,104,934;
U.S. Pat. Nos. 9,107,484; 9,111,159;
U.S. Pat. Nos. 9,111,166; 9,135,483;
U.S. Pat. Nos. 9,137,009; 9,141,839;
U.S. Pat. Nos. 9,147,096; 9,148,474;
U.S. Pat. Nos. 9,158,000; 9,158,340;
U.S. Pat. Nos. 9,158,953; 9,159,059;
U.S. Pat. Nos. 9,165,174; 9,171,543;
U.S. Pat. Nos. 9,183,425; 9,189,669;
U.S. Pat. Nos. 9,195,844; 9,202,458;
U.S. Pat. Nos. 9,208,366; 9,208,367;
U.S. Pat. Nos. 9,219,836; 9,224,024;
U.S. Pat. Nos. 9,224,027; 9,230,140;
U.S. Pat. Nos. 9,235,553; 9,239,950;
U.S. Pat. Nos. 9,245,492; 9,248,640;
U.S. Pat. Nos. 9,250,652; 9,250,712;
U.S. Pat. Nos. 9,251,411; 9,258,033;
U.S. Pat. Nos. 9,262,633; 9,262,660;
U.S. Pat. Nos. 9,262,662; 9,269,036;
U.S. Pat. Nos. 9,270,782; 9,274,812;
U.S. Pat. Nos. 9,275,388; 9,277,668;
U.S. Pat. Nos. 9,280,693; 9,286,496;
U.S. Pat. Nos. 9,298,964; 9,301,427;
U.S. Pat. Nos. 9,313,377; 9,317,037;
U.S. Pat. Nos. 9,319,548; 9,342,723;
U.S. Pat. Nos. 9,361,882; 9,365,381;
U.S. Pat. Nos. 9,373,018; 9,375,945;
U.S. Pat. Nos. 9,378,403; 9,383,848;
U.S. Pat. Nos. 9,384,374; 9,390,304;
U.S. Pat. Nos. 9,390,596; 9,411,386;
U.S. Pat. Nos. 9,412,242; 9,418,269;
U.S. Pat. Nos. 9,418,270; 9,465,967;
U.S. Pat. Nos. 9,423,318; 9,424,454;
U.S. Pat. Nos. 9,436,860; 9,443,123;
U.S. Pat. Nos. 9,443,222; 9,454,689;
U.S. Pat. Nos. 9,464,885; 9,465,967;
U.S. Pat. Nos. 9,478,983; 9,481,186;
U.S. Pat. Nos. 9,487,113; 9,488,986;
U.S. Pat. Nos. 9,489,782; 9,490,540;
U.S. Pat. Nos. 9,491,729; 9,497,092;
U.S. Pat. Nos. 9,507,974; 9,519,814;
U.S. Pat. Nos. 9,521,331; 9,530,038;
U.S. Pat. Nos. 9,572,901; 9,558,386;
U.S. Pat. Nos. 9,606,581; 9,646,189;
U.S. Pat. Nos. 9,646,191; 9,652,648;
U.S. Pat. Nos. 9,652,653; 9,656,487;
U.S. Pat. Nos. 9,659,198; 9,680,282;
U.S. Pat. Nos. 9,697,401; 9,701,140;
U.S. Design Pat. No. D702,237;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D734,339;
U.S. Design Pat. No. D737,321;
U.S. Design Pat. No. D754,205;
U.S. Design Pat. No. D754,206;
U.S. Design Pat. No. D757,009;
U.S. Design Pat. No. D760,719;
U.S. Design Pat. No. D762,604;
U.S. Design Pat. No. D766,244;
U.S. Design Pat. No. D777,166;
U.S. Design Pat. No. D771,631;
U.S. Design Pat. No. D783,601;
U.S. Design Pat. No. D785,617;
U.S. Design Pat. No. D785,636;
U.S. Design Pat. No. D790,505;
U.S. Design Pat. No. D790,546;
International Publication No. 2013/163789;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0194692;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0332996;
U.S. Patent Application Publication No. 2014/0001267;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131443;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0191684;
U.S. Patent Application Publication No. 2014/0191913;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0231500;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0332590;
U.S. Patent Application Publication No. 2014/0351317;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0009338;
U.S. Patent Application Publication No. 2015/0014416;
U.S. Patent Application Publication No. 2015/0021397;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0049347;
U.S. Patent Application Publication No. 2015/0051992;
U.S. Patent Application Publication No. 2015/0053769;
U.S. Patent Application Publication No. 2015/0062366;
U.S. Patent Application Publication No. 2015/0063215;
U.S. Patent Application Publication No. 2015/0088522;
U.S. Patent Application Publication No. 2015/0096872;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0149946;
U.S. Patent Application Publication No. 2015/0161429;
U.S. Patent Application Publication No. 2015/0178523;
U.S. Patent Application Publication No. 2015/0178537;
U.S. Patent Application Publication No. 2015/0178685;
U.S. Patent Application Publication No. 2015/0181109;
U.S. Patent Application Publication No. 2015/0199957;
U.S. Patent Application Publication No. 2015/0210199;
U.S. Patent Application Publication No. 2015/0212565;
U.S. Patent Application Publication No. 2015/0213647;
U.S. Patent Application Publication No. 2015/0220753;
U.S. Patent Application Publication No. 2015/0220901;
U.S. Patent Application Publication No. 2015/0227189;
U.S. Patent Application Publication No. 2015/0236984;
U.S. Patent Application Publication No. 2015/0239348;
U.S. Patent Application Publication No. 2015/0242658;
U.S. Patent Application Publication No. 2015/0248572;
U.S. Patent Application Publication No. 2015/0254485;
U.S. Patent Application Publication No. 2015/0261643;
U.S. Patent Application Publication No. 2015/0264624;
U.S. Patent Application Publication No. 2015/0268971;
U.S. Patent Application Publication No. 2015/0269402;
U.S. Patent Application Publication No. 2015/0288689;
U.S. Patent Application Publication No. 2015/0288896;
U.S. Patent Application Publication No. 2015/0310243;
U.S. Patent Application Publication No. 2015/0310244;
U.S. Patent Application Publication No. 2015/0310389;
U.S. Patent Application Publication No. 2015/0312780;
U.S. Patent Application Publication No. 2015/0327012;
U.S. Patent Application Publication No. 2016/0014251;
U.S. Patent Application Publication No. 2016/0025697;
U.S. Patent Application Publication No. 2016/0026838;
U.S. Patent Application Publication No. 2016/0026839;
U.S. Patent Application Publication No. 2016/0040982;
U.S. Patent Application Publication No. 2016/0042241;
U.S. Patent Application Publication No. 2016/0057230;
U.S. Patent Application Publication No. 2016/0062473;
U.S. Patent Application Publication No. 2016/0070944;
U.S. Patent Application Publication No. 2016/0092805;
U.S. Patent Application Publication No. 2016/0101936;
U.S. Patent Application Publication No. 2016/0104019;
U.S. Patent Application Publication No. 2016/0104274;
U.S. Patent Application Publication No. 2016/0109219;
U.S. Patent Application Publication No. 2016/0109220;
U.S. Patent Application Publication No. 2016/0109224;
U.S. Patent Application Publication No. 2016/0112631;
U.S. Patent Application Publication No. 2016/0112643;
U.S. Patent Application Publication No. 2016/0117627;
U.S. Patent Application Publication No. 2016/0124516;
U.S. Patent Application Publication No. 2016/0125217;
U.S. Patent Application Publication No. 2016/0125342;
U.S. Patent Application Publication No. 2016/0125873;
U.S. Patent Application Publication No. 2016/0133253;
U.S. Patent Application Publication No. 2016/0171597;
U.S. Patent Application Publication No. 2016/0171666;
U.S. Patent Application Publication No. 2016/0171720;
U.S. Patent Application Publication No. 2016/0171775;
U.S. Patent Application Publication No. 2016/0171777;
U.S. Patent Application Publication No. 2016/0174674;
U.S. Patent Application Publication No. 2016/0178479;
U.S. Patent Application Publication No. 2016/0178685;
U.S. Patent Application Publication No. 2016/0178707;
U.S. Patent Application Publication No. 2016/0179132;
U.S. Patent Application Publication No. 2016/0179143;
U.S. Patent Application Publication No. 2016/0179368;
U.S. Patent Application Publication No. 2016/0179378;
U.S. Patent Application Publication No. 2016/0180130;
U.S. Patent Application Publication No. 2016/0180133;
U.S. Patent Application Publication No. 2016/0180136;
U.S. Patent Application Publication No. 2016/0180594;
U.S. Patent Application Publication No. 2016/0180663;
U.S. Patent Application Publication No. 2016/0180678;
U.S. Patent Application Publication No. 2016/0180713;
U.S. Patent Application Publication No. 2016/0185136;
U.S. Patent Application Publication No. 2016/0185291;
U.S. Patent Application Publication No. 2016/0186926;
U.S. Patent Application Publication No. 2016/0188861;
U.S. Patent Application Publication No. 2016/0188939;
U.S. Patent Application Publication No. 2016/0188940;
U.S. Patent Application Publication No. 2016/0188941;
U.S. Patent Application Publication No. 2016/0188942;
U.S. Patent Application Publication No. 2016/0188943;
U.S. Patent Application Publication No. 2016/0188944;
U.S. Patent Application Publication No. 2016/0189076;
U.S. Patent Application Publication No. 2016/0189087;
U.S. Patent Application Publication No. 2016/0189088;
U.S. Patent Application Publication No. 2016/0189092;
U.S. Patent Application Publication No. 2016/0189284;
U.S. Patent Application Publication No. 2016/0189288;
U.S. Patent Application Publication No. 2016/0189366;
U.S. Patent Application Publication No. 2016/0189443;
U.S. Patent Application Publication No. 2016/0189447;
U.S. Patent Application Publication No. 2016/0189489;
U.S. Patent Application Publication No. 2016/0192051;
U.S. Patent Application Publication No. 2016/0202951;
U.S. Patent Application Publication No. 2016/0202958;
U.S. Patent Application Publication No. 2016/0202959;
U.S. Patent Application Publication No. 2016/0203021;
U.S. Patent Application Publication No. 2016/0203429;
U.S. Patent Application Publication No. 2016/0203797;
U.S. Patent Application Publication No. 2016/0203820;
U.S. Patent Application Publication No. 2016/0204623;
U.S. Patent Application Publication No. 2016/0204636;
U.S. Patent Application Publication No. 2016/0204638;
U.S. Patent Application Publication No. 2016/0227912;
U.S. Patent Application Publication No. 2016/0232891;
U.S. Patent Application Publication No. 2016/0292477;
U.S. Patent Application Publication No. 2016/0294779;
U.S. Patent Application Publication No. 2016/0306769;
U.S. Patent Application Publication No. 2016/0314276;
U.S. Patent Application Publication No. 2016/0314294;
U.S. Patent Application Publication No. 2016/0316190;
U.S. Patent Application Publication No. 2016/0323310;
U.S. Patent Application Publication No. 2016/0325677;
U.S. Patent Application Publication No. 2016/0327614;
U.S. Patent Application Publication No. 2016/0327930;
U.S. Patent Application Publication No. 2016/0328762;
U.S. Patent Application Publication No. 2016/0330218;
U.S. Patent Application Publication No. 2016/0343163;
U.S. Patent Application Publication No. 2016/0343176;
U.S. Patent Application Publication No. 2016/0364914;
U.S. Patent Application Publication No. 2016/0370220;
U.S. Patent Application Publication No. 2016/0372282;
U.S. Patent Application Publication No. 2016/0373847;
U.S. Patent Application Publication No. 2016/0377414;
U.S. Patent Application Publication No. 2016/0377417;
U.S. Patent Application Publication No. 2017/0010141;
U.S. Patent Application Publication No. 2017/0010328;
U.S. Patent Application Publication No. 2017/0010780;
U.S. Patent Application Publication No. 2017/0016714;
U.S. Patent Application Publication No. 2017/0018094;
U.S. Patent Application Publication No. 2017/0046603;
U.S. Patent Application Publication No. 2017/0047864;
U.S. Patent Application Publication No. 2017/0053146;
U.S. Patent Application Publication No. 2017/0053147;
U.S. Patent Application Publication No. 2017/0053647;
U.S. Patent Application Publication No. 2017/0055606;
U.S. Patent Application Publication No. 2017/0060316;
U.S. Patent Application Publication No. 2017/0061961;
U.S. Patent Application Publication No. 2017/0064634;
U.S. Patent Application Publication No. 2017/0083730;
U.S. Patent Application Publication No. 2017/0091502;
U.S. Patent Application Publication No. 2017/0091706;
U.S. Patent Application Publication No. 2017/0091741;
U.S. Patent Application Publication No. 2017/0091904;
U.S. Patent Application Publication No. 2017/0092908;
U.S. Patent Application Publication No. 2017/0094238;
U.S. Patent Application Publication No. 2017/0098947;
U.S. Patent Application Publication No. 2017/0100949;
U.S. Patent Application Publication No. 2017/0108838;
U.S. Patent Application Publication No. 2017/0108895;
U.S. Patent Application Publication No. 2017/0118355;
U.S. Patent Application Publication No. 2017/0123598;
U.S. Patent Application Publication No. 2017/0124369;
U.S. Patent Application Publication No. 2017/0124396;
U.S. Patent Application Publication No. 2017/0124687;
U.S. Patent Application Publication No. 2017/0126873;
U.S. Patent Application Publication No. 2017/0126904;
U.S. Patent Application Publication No. 2017/0139012;
U.S. Patent Application Publication No. 2017/0140329;
U.S. Patent Application Publication No. 2017/0140731;
U.S. Patent Application Publication No. 2017/0147847;
U.S. Patent Application Publication No. 2017/0150124;
U.S. Patent Application Publication No. 2017/0169198;
U.S. Patent Application Publication No. 2017/0171035;
U.S. Patent Application Publication No. 2017/0171703;
U.S. Patent Application Publication No. 2017/0171803;
U.S. Patent Application Publication No. 2017/0180359;
U.S. Patent Application Publication No. 2017/0180577;
U.S. Patent Application Publication No. 2017/0181299;
U.S. Patent Application Publication No. 2017/0190192;
U.S. Patent Application Publication No. 2017/0193432;
U.S. Patent Application Publication No. 2017/0193461;
U.S. Patent Application Publication No. 2017/0193727;
U.S. Patent Application Publication No. 2017/0199266;
U.S. Patent Application Publication No. 2017/0200108;
U.S. Patent Application Publication No. 2017/0200275;

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

What is claimed is:

1. A method of self-stabilizing a forklift having a volume dimensioning device, a weight sensor, and a gyroscopic disc when the forklift is lifting an object, comprising:
determining dimensions and volume of the object with the volume dimensioning device;
determining a weight of the object with the weight sensor;
calculating an approximate center of gravity of the object; and
stabilizing the forklift when lifting the object by rotating the gyroscopic disc at a rotational speed based on the determined weight and calculated approximate center of gravity of the object.

2. The method of self-stabilizing the forklift of claim 1, wherein the volume dimensioning device is a 3D range camera.

3. The method of self-stabilizing the forklift of claim 1, wherein the weight sensor is a barcode reader operable to read a barcode positioned on the object, the barcode encoding a weight of the object.

4. The method of self-stabilizing the forklift of claim 1, wherein the forklift comprises a plurality of gyroscopic discs.

5. The method of self-stabilizing the forklift of claim 4, comprising rotating two or more gyroscopic discs when the forklift lifts the object, the rotational speed of the rotating gyroscopic discs being based on the approximate center of gravity and determined weight of the object.

6. The method of self-stabilizing the forklift of claim 4, wherein each gyroscopic disc has a different diameter and weight than the other gyroscopic discs.

7. The method of stabilizing a forklift of claim 4, wherein when a total stabilizing force generated by rotating all the plurality of gyroscopic discs exceeds a stabilizing force needed to stabilize the forklift when lifting the object, a first gyroscopic disc is rotated, and a second gyroscopic disc remains stationary.

8. The method of self-stabilizing the forklift of claim 1, wherein the forklift further comprises a processor in communication with the volume dimensioning device and weight sensor, the processor being operable to:
receive the calculated volume and dimensions from the volume dimensioning device, and the determined weight from the weight sensor;
perform the calculation of the approximate center of gravity of the object based on the calculated volume and dimensions and determined weight of the object;
control a rotational speed of the gyroscopic disc; and
responsive to the calculated approximate center of gravity and determined weight of the object, adjust the rotational speed of the gyroscopic disc.

9. The method of self-stabilizing the forklift of claim 1, wherein the volume dimensioning device is positioned on a mast of the forklift.

10. The method of stabilizing a forklift of claim 1, wherein the weight sensor is attached to a mast of the forklift and is configured to measure the weight of the object as the object is lifted by the forklift.

11. A method of stabilizing a forklift, comprising:
determining a weight of an object with a weight sensor;
determining dimensions and volume of the object with a volume dimensioning device;
calculating an approximate center of gravity of the object based on the determined dimensions and volume of the object;
rotating a gyroscopic disc positioned in a disc receiving space of the forklift at a rotational speed sufficient to stabilize the forklift when lifting the object, the rotational speed of the gyroscopic disc being based on the approximate center of gravity and the determined weight of the object.

12. The method of stabilizing a forklift of claim 11, wherein the volume dimensioning device is a 3D range camera.

13. The method of stabilizing a forklift of claim 11, wherein the volume dimension device is attached to a mast of the forklift.

14. The method of stabilizing a forklift of claim 11, wherein the weight sensor is attached to a mast of the forklift and is configured to measure the weight of the object as the object is lifted by the forklift.

15. The method of stabilizing a forklift of claim 11, wherein the forklift comprises a processor in communication with the volume dimensioning device and weight sensor, the processor being configured to calculate the approximate center of gravity.

16. The method of stabilizing a forklift of claim 15, wherein the processor is in communication with a motor controlling a rotational speed of gyroscopic disc, and instructs the motor to adjust the rotational speed of the gyroscopic disc in response to the determined weight and approximate center of gravity of the object.

17. The method of stabilizing a forklift of claim 11, wherein the forklift comprises a plurality of gyroscopic discs.

18. The method of stabilizing a forklift of claim 17, wherein each gyroscopic disc has a different diameter and weight than the other gyroscopic discs.

19. The method of stabilizing a forklift of claim 17, wherein when a total stabilizing force generated by rotating all the plurality of gyroscopic discs exceeds a stabilizing force needed to stabilize the forklift when lifting the object, a first gyroscopic disc is rotated, and a second gyroscopic disc remains stationary.

20. The method of stabilizing a forklift of claim 11, wherein the weight sensor is a barcode reader operable to read a barcode positioned on an object to be lifted, the barcode encoding a weight of the object
